(19) United States
(12) Patent Application Publication
(10) Pub. No.: US 2004/0194083 A1
(43) Pub. Date: Sep. 30, 2004

(54) Program installation process

(76) Inventors: Ian Hindle, Suffolk (GB); Marcus Porter, Larne (GB)

Correspondence Address: NIXON & VANDERHYE, PC, 1100 N GLEBE ROAD, 8TH FLOOR, ARLINGTON, VA, 22201-4714, US

(21) Appl. No.: 10/481,590

(22) PCT Filed: Jul. 1, 2002
(86) PCT No.: PCT/GB02/03047

(30) Foreign Application Priority Data
Jul. 2, 2001 (EP) 01305714.6
Jul. 12, 2001 (GB) 0117053.9

(51) Int. Cl. G06F 9/445; G06F 9/44

(52) U.S. Cl. 717/174; 717/168

(57) ABSTRACT

Operating software is installed in a computer terminal from a data carrier such as a CD ROM. The data carrier has generic software components which automatically access a server, and transmit details of the terminal's operating system to allow the server to download information for installation of the operating software specific to the terminal's operating system. This allows reconfiguration to be carried out automatically to accommodate a new capability, with minimal input from the user.

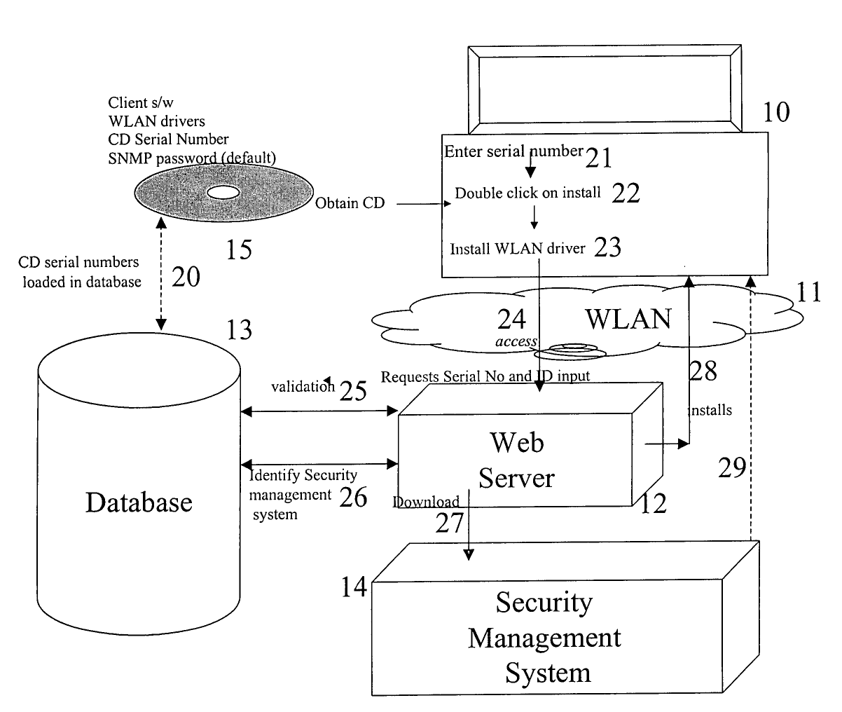

This invention relates to the installation of operating software to personal computers and other consumer equipment, such as the software required for the computer to operate with newly installed hardware. Such hardware is typically embodied as a set of electronic components and the necessary connections for fitting to a computer, either to provide a new capability or to upgrade an existing one. In order for the computer to operate correctly with the new hardware installed, a reconfiguration procedure has to be carried out to ensure that the computer recognises the presence and purpose of the new hardware. Similar reconfiguration may be necessary if the computer is to be connected through a new communications system, or to carry out new processes in co-operation with other remote apparatus. These re-configurations do not necessarily involve the installation of new hardware.

The reconfiguration can be an intensive process requiring a considerable amount of technical knowledge by the user, and the details of the process vary from one machine to another depending both on its original design and any previous reconfigurations which may have been made. Information may also be required about various network servers to which the computer is connected in order to correctly configure the computer. It is therefore difficult for a supplier to provide simple instructions suitable for a lay person to perform the process. Some systems provide step-by-step instructions for the user to perform as the installation proceeds, but nevertheless require the user to provide input of several pieces of information he may not readily have to hand.

The present invention allows the process to be automated, requiring only a single “run” instruction from the user. It also ensures that when a user subsequently uses the downloaded software, the user is an authorised user of that software and is not using an unauthorised copy. The invention will be described, for illustrative purposes, in relation to an embodiment for the configuration of a computer to communicate over a suitable telecommunications system using an Internet Security Protocol (IPSec) client, or over a Wireless LAN (local area network). However, other applications of the invention can be envisaged and the embodiment is not to be taken as limitative.

According to the invention there is provided a method of installing operating software in a computer terminal in which generic software components are installed for:

automatically accessing a server,

transmitting details of the terminal's operating system to the server,

downloading specific information for installation of the operating software from the server according to the terminal's operating system,

verifying a user identity carried in the operating software,

and obtaining a certification code from the server for authentication of the terminal during any future communication.

This certification code prevents the use of unauthorised copies of the downloaded software since such copies, downloaded from an authorised terminal, would not obtain a correct code from the server.

The generic software may perform any desrired function. In the described embodiment it comprises communications interface software. The server may be arranged to allow access to the installation software only from specified users, for example by use of a firewall system or a password control system. The password may be a product key associated with a data carrier carrying the generic software components, the server permitting only a limited number of accessions (typically just one) by users using any one product key.

The invention also extends to a data carrier for carrying the generic software components used in this method. Although in the described embodiment it takes the form of a CD-ROM, the computer program product may be embodied on any suitable carrier readable by a suitable computer input device, and may take the form of optically readable marks, magnetic media, punched card or tape, or an electromagnetic (radio frequency or optical) or ultrasonic signal. The carrier may carry programming for several services, accessible by different users or user groups.

The invention also extends to a general-purpose computer programmed to operate as a server and having means for receiving details of a terminal's operating system, means for generating specific information according to the terminal's operating system for installation of operating software on the terminal's operating system, a database for storing user identities, means for generating a certification code for transmission to a terminal during the installation process, and means for verification of a terminal identity transmitted to the computer by a terminal's operating system. Preferably it has means for identifying, by interrogation of a terminal, the specific configuration of that terminal and for providing the installation software necessary for that configuration. It may also have access control means to allow access to the installation software only from specified users.

The server may be a privately operated server, for example run by a business for use by its employees, using a “firewall” system to allow access only from those employees' terminals. Alternatively it may be an external website, with controls in place such as password control to control access to the installation software. The installation software can be available to anyone granted access rights—the program provider may grant access rights through one or more corporate internets (“intranets”), or to individuals. In either case the server has means for identifying, by interrogation of the client computer, the specific configuration of the client computer and provide the necessary installation software. This removes the need for the human user to provide any input.

Preferably the generic software comprises communications interface software such as client software and Wireless LAN drivers

The verification of a user identity carried in the operating software ensures that the carrier on which the program is carried (typically a CD-ROM having a unique identity code) has not been previously used by another user and therefore has not been cloned, and verifies the user as legitimate.

The invention may be embodied in any suitable computer language, and capable of operation with any operating system supported by standard computers.

The invention allows a single-click process, requiring no configuration input from the user, to be used to automatically install and configure systems such as WLAN drivers and security technology. No other information is required from the user as a web-site hosted by the security body provides the specific configuration information required for the user's needs. This web-site is accessed automatically as part of the process. No network specific inputs are required from the user, therefore the data carrier carrying the programming that initiates the process can be generic for multiple, different deployments.

A validation database may be provided to enable the organisation providing the service to restrict the user base. In advance the company can determine exactly who can access the service—for example a wireless local area network (WLAN)—and can easily amend or revoke privileges. Installation data carriers, typically CD-ROMs can be provided from any location without need for training, and specifics of installation are performed via a web-site configured for the company.

An illustrative embodiment of the invention will now be discussed, by way of example, with reference to the FIGURE, which is a schematic representation of the various elements which co-operate to perform the invention (indicated by reference numerals beginning with a “1”), incorporating representations of information transfers illustrating the operation of the invention (indicated by reference numerals beginning with a “2”).

The FIGURE shows a personal computer 10 connected by way of a network 11 to a server 12 having access to a validation database 13, and a security management system 14. A data carrier 15, such as a compact disc read-only memory (CDROM), is used to carry the required programming. The CDROM is used in this embodiment purely for illustrative purposes; the carrier 15 may take any suitable form, such as a signal carried over a suitable transmission medium such as the network 11.

The user terminal 10 is a user's laptop or desktop computer. The client software and wireless hardware are installed onto this device allowing the user to communicate securely over the wireless link 11.

The server may be a privately operated server serving a limited number of user terminals (10 etc) to which the installation software must first be supplied when the operator of the server wishes its client servers to have the software installed. Alternatively the server 12 may be accessed as a website operated by the creator of the software and having the installation software made available to any authorised user.

The server 12 is used during the install process to ascertain the user's operating system requirements and then downloads the specific configuration information according to the user's needs. This downloaded information is then used to complete the install process.

The validation database 13 allows the provider of the service to specify the identities of users who are entitled to use the service enabled by the program on the data carrier 10. The carrier may carry programming for several services, accessible by different users or user groups.

The server 12 is also used to access the validation database 13 to allow users to register a product key code (provided with the installation CDROM) to download an encrypted Secure Internet Protocol Configuration file. This configuration file is decrypted by a set-up program, and the parameters are used to launch the Secure Internet Protocol set-up program.

The Security Management System 14 provides network security and administration, issues certificates as a public key encrypted document to each authorised user who installs the system.

When users subsequently access the system, these certificates can be used to verify the authenticity of the user. A list of every client is stored on the Security management system 14, giving such information as the time and date that the secure certificate was issued, and the last time the certificate was revised or renewed.

The operation of this embodiment of the invention will now be described in detail. There are some differences in operation depending on whether the server 12 has the software already loaded.

If the server 12 does not already have the software the operator of the server first has to receive from the supplier a server application program, for example on a CD-ROM, for installation on the server 12. It also receives a batch of Client CDs, for distibution to its employees or other users who are to use the installation service. With this batch is provided a list of product key codes stored in encrypted format. This list can be supplied in any suitable form, preferably electronic, such as e-mail or floppy disc.

When the operator of the server 12 installs the server software the application requests this list of product keys. It will use these keys when verifying a client installation request.

If the installation software is already available, through a website, valid product keys are entered on the database 13 when client CDs having the same product key codes are distributed.

The product key code is printed on the packaging of each client CDROM, or in other accompanying literature, each corresponding to one of the codes entered in the validation database 13 (step 20). When a user receives the installation CDROM 15, he installs the CDROM on his user terminal 10. The installation program on the CDROM causes the terminal 10 to access the appropriate server 12, either directly if connected by a local area network, or otherwise via a suitable website, to attempt registration (step 21).

The server 12 initiates a user interface dialog and returns a request for the product key code which the user then supplies (step 22).

From this point the process is automatic—the human user has no further input to make.

The set up process runs on the user terminal 10 as follows.

The user terminal first accesses the server 12 (step 22) for the configuration file previously installed there. This configuration process first verifies the product key previously entered by the user. If this is validated the server 12 sends the configuration file to the client terminal 10. Firstly, if required, the Wireless LAN card driver is installed (step 23). This will cause the computer to reboot its operating system (e.g. Microsoft Windows™ NT or 2000) so that operating system will recognise the new driver, but the installation process may continue automatically whilst this is going on.

In the next step the installation program accesses the server 12 (step 24), which queries the database 13 (step 25) to ensure that the user is permitted to use the system. The checks carried out may include identification of the terminal 10 itself, or of the telecommunications line 11 by which the terminal 10 accessed the system. The server 12 also verifies that the product key that was entered exists in the database 13, and has not already been registered by another user.

If any of the above tests fail, an error message is displayed. Otherwise, if the product key is valid and has not previously been registered, the server 12 proceeds to the next stage.

The server 12 next queries the database 13 to determine the security management system 14 associated with this particular key (step 26). This association is set up on creation of the key (step 20).

A configuration file unique to the user is then dynamically created in the security management system 14 (step 27). This is simply a string of command line parameters generated by the security management system 14, encrypted and then written to a file on the security management system 14.

The configuration file is also sent to the user terminal 10 as a text file, where it is saved to the hard disk of the terminal 10 (step 29). If the server 12 is the one to which the user terminal 10 is operating, this can be downloaded directly. However, if the user terminal 10 is accessing the configuration program through a website, the website server 12 presents a web page to the user (step 28). This page has a link to the configuration file on the security management system 14, and an instruction requesting the user to use the link to download and save the configuration file on to the hard disk of the computer 10 (step 29).

Once saved on the hard disk, the configuration file is searched for automatically on each subsequent boot-up of the computer, and is read and decrypted, thereby causing the launch of the set-up program, which is passed the command line parameters from the decrypted configuration file.

1. A method of installing operating software in a computer terminal in which generic software components are installed for:
automatically accessing a server, transmitting details of the terminal's operating system to the server, downloading specific information for installation of the operating software
from the server according to the terminal's operating system, verifying a user identity carried in the operating software,
and obtaining a certification code from the server for authentication of the terminal during any future communication.

2. A method according to claim 1, wherein the generic software comprises communications interface software.

3. A method according to claim 1, wherein the server allows access to the installation software only from specified users.

4. A method according to claim 3, wherein the server comprises a firewall system.

5. A method according to claim 3, wherein access to the server is enabled by transmission of a password.

6. A method according to claim 5, wherein the password is a product key associated with a data carrier carrying the generic software components.

7. A method according to claim 6, wherein the server permits only a limited number of accessions by users using any one product key.

8. A data carrier carrying generic software components for use in the method of claim 1.

9. A data carrier according to claim 8, carrying programming for several services, accessible by different users or user groups.

10. A data carrier according to claim 8, comprising a recording medium carrying data for reading by a reading device associated with the terminal on which the software is to be installed.

11. A general-purpose computer programmed to operate as a server and having means for receiving details of a terminal's operating system, means for generating specific information according to the terminal's operating system for installation of operating software on the terminal's operating system, a database for storing user identities, means for generating a certification code for transmission to a terminal during the installation process, and means for verification of a terminal identity transmitted to the computer by a terminal's operating system.

12. A computer according to claim 11 having means for identifying, by interrogation of a terminal, the specific configuration of the terminal and means for providing the installation software necessary for that configuration.

13. A computer according to claim 11, comprising access control means to allow access to the installation software only from specified users.

14. A computer according to claim 13, wherein the access control means comprises a firewall system having means for allowing access only by specified terminals or communications lines.

15. A computer according to claim 13, wherein the access control means comprises a password system.
